(19) United States
(12) Patent Application Publication
(10) Pub. No.: US 2007/0004815 A1
(43) Pub. Date: Jan. 4, 2007

(54) SELF-PHOTOINITIATING MULTIFUNCTIONAL URETHANE OLIGOMERS CONTAINING PENDANT ACRYLATE GROUPS

(75) Inventors: Sridevi Narayan-Sarathy, Dublin, OH (US); Michael Gould, Powell, OH (US)

Correspondence Address: CONNOLLY BOVE LODGE & HUTZ LLP, P.O. BOX 2207, WILMINGTON, DE, 19899-2207, US

(73) Assignee: Ashland Licensing and Intellectual Property LLC, Columbus, OH (US)

(21) Appl. No.: 11/160,597

(22) Filed: Jun. 30, 2005

(51) Int. Cl. H05B 6/68; C08G 18/00

(52) U.S. Cl. 522/1; 528/44

(57) ABSTRACT

The present invention relates to self-photoinitiating multifunctional urethane acrylate compositions. More particularly, the present invention relates to liquid oligomeric multifunctional acrylate compositions having pendant acrylate groups and tertiary amine groups bound as part of the polymer structure. The compositions of the present invention cure upon exposure to active radiation such as UV light in the absence of an added photoinitiator. Films made from the crosslinked oligomers of the invention are used as protective or decorative coatings on various substrates. These oligomers can be added to other resins used in adhesives or composites.

### TECHNICAL FIELD

The present invention relates to self-photoinitiating multifunctional acrylate compositions having novel architecture. More particularly, the present invention relates to liquid oligomeric multifunctional acrylate compositions having tertiary amine groups bound as part of the polymer back-bone and acrylic groups present as pendant moieties. The compositions of the present invention cure upon exposure to actinic radiation in the absence of an added photoinitiator. Films made from the crosslinked oligomers of the invention are used as protective or decorative coatings on various substrates. The oligomers can also be used in the making of adhesives or composites.

### BACKGROUND OF THE INVENTION

The invention detailed herein comprises a family of novel multifunctional urethane acrylate resins, having pendant acrylate groups and covalently-bound tertiary amine groups, which act as synergists in the free radical polymerization of acrylic moieties. These are further made self-photoinitiating by their reaction with β-keto esters (e.g., acetoacetates), β-diketones (e.g., 2, 4-pentanedione), β-keto amides (e.g., acetoacetanilide, acetoacetamide), and/or other β-dicarbonyl compounds that can participate in the Michael addition reaction as “Michael donors.”

These novel resins are characterized by the presence of acrylate groups as pendant moieties, by “built-in” tertiary amine synergist groups to overcome oxygen inhibition, and by the ability of these resins to cure under standard UV-cure conditions to give tack-free coatings without the addition of traditional photoinitiators. The “comb” structure of these compounds results in unique properties useful in low profile additives and other applications.

Multifunctional acrylates and methacrylates (“acrylates”) are commonly utilized in the preparation of crosslinked films, adhesives, foundry sand binders, composite structures, and other materials. Acrylate monomers and oligomers may be crosslinked by free radical chain mechanisms, which may require any of a number of free radical generating species, such as peroxides, hydroperoxides, or azo compounds, that may decompose to form radicals either when heated, or at ambient temperatures in the presence of promoters.

An alternative means of initiating reaction is the use of ultraviolet (UV) light or electron beam (EB) radiation to decompose photoinitiators into reactive free radical species. For numerous applications, this method offers the potential for extremely rapid processing because the transformation from a liquid reactive composition to a crosslinked solid is essentially instantaneous upon exposure to UV or EB radiation.

A drawback to the use of initiators to effect free radical reaction is the decomposition of initiators and photoinitiators, producing low molecular weight fragments that may volatilize or leach out during and/or after curing. These fugitive fragments can have a negative impact on the safety of workers, consumers, and the environment. For instance, these low molecular weight fragments tend to be readily absorbed through skin which can cause adverse health effects.

Another drawback is that free radical reactions of acrylates are typically inhibited by oxygen, i.e. the presence of oxygen prevents complete reaction and/or slows the rate of reaction.

These limitations have been addressed in several key approaches. The challenge of fugitive emissions during manufacturing processes or subsequent leaching of photoinitiator fragments has been addressed by creating acrylate monomers/oligomers with “built-in” photoinitiators. This may be accomplished by starting with a compound which is known to function as a photoinitiator (or a suitable derivative) and either functionalizing it with an appropriate unsaturated group, i.e. acrylate or methacrylate, so as to produce a new compound which functions as both monomer/oligomer and photoinitiator, or by “grafting” onto a pre-formed oligomer/polymer in order to produce a higher molecular weight photoinitiator.

Regardless of the effectiveness of these methods, they add additional manufacturing complexity and costs.

Moreover, these approaches result in resins of low functionality. Low functionality is detrimental to reactivity and final properties, and may impose a requirement for addition of catalyst or initiator to maximize crosslinking.

A recent and effective solution is described in U.S. Pat. Nos. 5,945,489 and 6,025,410 to Moy et al and assigned to Ashland, Inc., the assignee of the present application. Such approach involves reacting multifunctional acrylates with β-keto esters (e.g., acetoacetates) and/or β-diketones via the Michael addition reaction in ratios that yield uncrosslinked, acrylate-functional resins. These resins crosslink upon exposure to an appropriate UV source in the absence of added photoinitiators.

Oxygen inhibition of free radical acrylate reactions can be eliminated by inerting, i.e. exclusion of oxygen with inert gases, nitrogen, argon, or carbon dioxide being the most common. While this is an obvious solution, it is generally most appropriate for research or for specialty purposes since it is often impractical or prohibitively expensive for large-scale industrial applications. Another option, frequently more attractive from a cost perspective, is the use of amine synergists, tertiary amines which improve surface cure by enhancing free radical polymerization. A wide variety of synergists are available, and even simple compounds such as common ethanolamine derivatives may function as effective synergists. However, as these are generally somewhat lower molecular weight compounds which must be present at 5 to as much as 15% (by weight) of a formulation in addition to added photoinitiators, fugitive emissions or subsequent leaching remain a potential problem.

Accordingly, considerable room still exists for improvement, such as addressing problems associated with added low molecular weight photoinitiators and synergists.

U.S. Pat. No. 6,673,851, assigned to Ashland, Inc., the assignee of the present invention, discloses a way to significantly reduce problems associated with added low molecular weight synergists by incorporating appropriate functional groups for these purposes into multifunctional acrylates/acrylate functional oligomers. More particularly, that invention related to self-photoinitiating liquid oligomeric acrylate compositions having tertiary amine groups bound as part of the polymer structure. These resins are synthesized by the “pseudo Michael addition reaction” of secondary amines and an uncrosslinked Michael addition product of a multifunctional acrylate acceptor and a Michael donor, wherein the amount of Michael donor is not sufficient to effect crosslinking.

Subsequent experiments showed that these resins have a decreased crosslink density and therefore diminished physical properties in some applications. This is probably due to the reduction in acrylic groups available for cross-linking due to “consumption” via pseudo Michael reactions with secondary amines. The resins of the present invention circumvent this problem by incorporating the tertiary amine in the backbone of the resin without consumption of acrylic moieties necessary for development of physical properties.

### SUMMARY OF THE INVENTION

The present invention relates to significantly reducing, if not eliminating, problems associated with added low molecular weight photoinitiators and synergists by incorporating appropriate functional groups for these purposes into multifunctional acrylates/acrylate functional oligomers.

The present invention relates to multi-functional acrylate resins providing thermosets having high crosslink densities with good tensile and adhesion properties.

In particular, the present invention is directed to a self-photoinitiating liquid oligomeric composition having tertiary amine groups and pendant acrylate groups obtained by the reaction of a β-dicarbonyl monomer having two active hydrogen atoms; and two N-bis-(urethane acrylate) tertiary amino acrylate oligomers, wherein each said oligomer is covalently linked to the methylene group of the Michael donor.

In particular, the present invention is directed to self-photoinitiating liquid oligomeric compositions having tertiary amine groups and pendant acrylate groups obtained by the reaction of two Michael oligomer molecules containing primary hydroxyl groups with the terminal isocyanate groups of an N-bis-(urethane) tertiary amino acrylate oligomer. In this embodiment, the β-dicarbonyl chromophore is incorporated towards the periphery of the resin.

In a further embodiment, a β-dicarbonyl chromophore is located in the center of the resin with N-bis-(urethane) tertiary amino acrylate oligomers branching from the dicarbonyl.

An aspect of the present invention provides oligomers used to synthesize the inventive resins.

An aspect of the present invention provides an acrylate-functional dialkanol amine obtained by the Michael-type addition of a multi-functional acrylate monomer or oligomer with a dialkanol amine.

An aspect of the present invention provides an isocyanate end-capped N-bis-(urethane) tertiary amino acrylate oligomer obtained by the reaction of acrylate-functional dialkanol amine with excess diisocyanate in the presence or absence of an additional glycol moiety.

An aspect of the present invention provides an N-bis-(acrylate-terminated urethane) tertiary amino acrylate oligomer by the reaction of N-bis-(isocyanate-terminated urethane) tertiary amino acrylate oligomer with stoichiometric amount of a hydroxyl group-containing acrylate monomer.

The present invention further relates to methods useful to synthesize the oligomers and resins of the present invention.

The present invention also relates to crosslinked products obtained by subjecting the above-disclosed self-photoinitiating liquid oligomeric compositions to actinic light such as UV radiation.

The present invention also relates to curing the above-disclosed self-photoinitiating liquid oligomeric compositions by exposing the compositions to actinic light.

Another aspect of the present invention relates to methods comprising applying the inventive self-photoinitiating liquid oligomeric composition to a substrate and then exposing the composition to actinic light.

A still further aspect of the present invention relates to the product obtained by the inventive method.

Still other objects and advantages of the present invention will become readily apparent by those skilled in the art from the following detailed description, wherein it is shown and described by preferred embodiments of the invention, simply by way of illustration of the best mode contemplated of carrying out the invention. As will be realized, the invention is capable of other and different embodiments, and its several details are capable of modifications in various obvious respects, without departing from the invention. Accordingly, the description is to be regarded as illustrative in nature and not as restrictive.

### BRIEF DESCRIPTION OF THE DRAWINGS

The invention is best understood from the following detailed description when read in connection with the accompanying drawings. It is emphasized that, according to common practice, the various features of the drawing are not to scale. On the contrary, the dimensions of the various features are arbitrarily expanded or reduced for clarity. Included in the drawing are the following figures:

FIG. 1 is a schematic of the synthesis of a tertiary amino acrylate polyol oligomer (TMPO);

FIG. 2 is a schematic of the synthesis of a N-bis-(hydroxyl-terminated urethane) tertiary amino acrylate oligomer (N-bis-(HTU)TAA);

FIG. 3 is a schematic of the synthesis of an N-bis-(isocyanate-terminated urethane) tertiary amino acrylate oligomer (N-bis-(ITU)TAA);

FIG. 4 is a schematic of the synthesis of an N-bis-(acrylate-terminated urethane) tertiary amino acrylate oligomer (N-bis-(ATU)TAA);

FIG. 5 is a schematic of the synthesis of an N-bis-(urethane) tertiary amino acrylate based Michael resin having a central β-dicarbonyl chromophore;

FIG. 6 is a schematic of the synthesis of a free hydroxyl group containing Michael oligomer; and

FIG. 7 is a schematic of the synthesis of an N-bis-(urethane) tertiary amino acrylate based Michael resin having peripheral β-dicarbonyl chromophores.

It is to be noted, however, that the appended drawings illustrate only typical embodiments of this invention and are therefore not to be considered limiting of its scope, for the invention may admit to other equally effective embodiments.

### BEST AND VARIOUS MODES FOR CARRYING OUT INVENTION

The term monomer is herein defined as a molecule or compound, usually containing carbon and of relatively low molecular weight and simple structure, which is capable of conversion to polymers, synthetic resins, or elastomers by combination with other similar and/or dissimilar molecules or compounds.

The term oligomer is herein defined as a polymer molecule consisting of only a few similar and/or dissimilar monomer units. The present disclosure comprehends a Michael oligomer as the synthetic product containing at least one β-dicarbonyl monomer and a ‘pseudo Michael oligomer’ or ‘Michael-type oligomer’ as the synthetic product containing at least one tertiary amine and at least one polymerizable acrylate functionality.

The term resin is herein defined as an oligomer, which is capable of conversion to high molecular weight polymers by combination with other similar and/or dissimilar molecules or compounds. The present disclosure comprehends a Michael resin as the synthetic product containing at least one β-dicarbonyl monomer.

The term “bis,” as used herein, means the nitrogen is linked indirectly with two urethane groups. The term bis, as used herein, does not imply symmetrical substitution. The two urethane groups may be the same or different.

The term thermoset is herein defined to be a high molecular weight polymer product of resins that solidifies or sets irreversibly when “cured” (i.e., polymerization is deliberately induced). This property is associated with crosslinking reactions of the molecular constituents induced by heat, radiation, and/or chemical catalysis.

The present disclosure comprehends the term “polyol” to include diols.

Coating performance properties are measured by a variety of different test methods familiar to persons of skill in the art. Hardness and chemical resistance were assessed on aluminum panels, adhesion was assessed on steel panels, and mar resistance measurements were performed on white painted aluminum panels.

Hardness. Film hardness is the ability of a coating to resist cutting, scratching, shearing, or penetration by a hard object. A method of measuring the coating's hardness is to scratch the film with pencil leads of known hardness. The result is reported as the hardest lead that will not scratch or cut through the film to the substrate. While this test is quite subjective, it does provide a quick and rather reliable method to determine film hardness. As measured by the pencil method: soft <6B-5B-4B-3B-2B-B-HB-F-H-2H-3H-4H-5H-6H>hard. The method follows the procedure of ASTM D3363.

Solvent Resistance. Solvent resistance is the ability of a coating to resist solvent attack precipitating film delamination or “break-through” or film deformity. Rubbing the coating with a cloth saturated with an appropriate solvent is one way to assess when a specific level of solvent resistance is achieved. All rubbing tests were conducted using methyl ethyl ketone (MEK) and employed a double rub technique, one complete forward and backward motion over the coated surface. To normalize test strokes, cheesecloth was fixed to the round end of a 16-oz. ball peen hammer. The double rub technique utilizes the weight of the hammer as the operator holds the hammer at the base of the handle. This test was performed until the double rubbing action cut into the film or a noticeable film disorder was evident. The method is modified from the procedure of ASTM D4752.

Gloss. Gloss was measured at 60° incident angle to the surface with a BYK Gardner Micro-TRI-Gloss™ instrument. The method follows the procedure of ASTM D523.

Mar resistance. The measurement method employs an Atlas Crockmeter® and 0000 steel wool. The test method used is from ASTM D6279, using a black pigmented panel as a substrate and measuring 20° gloss before and after abrasion; or is modified from ASTM 6279 by using a white pigmented substrate panel and measuring 60° gloss. Mar resistance is reported in terms of % gloss retention, defined as (gloss of abraded coating/gloss of unabraded coating) X 100.

Adhesion. Adhesion was tested using phosphate treated steel Q-panels as the test coating substrate. (Q-panel® is a trademark of Q-Panel Lab Products, Cleveland, Ohio.). Adhesion testing was performed by the crosshatch method on rigid substrates using a modified method of ASTM D3359 by Test Tape Method B, using a Gardco Blade PA-2054 (11-tooth, 1.5 mm cutter). Test Tape used was Permacel #99. The ASTM test reports values from 0 B to 5 B, with 0 B being a total failure, and 5 B characterizing excellent adhesion.

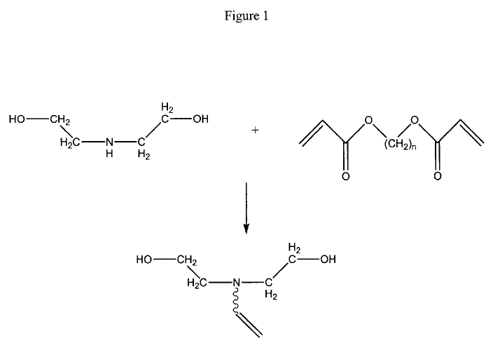

Synthesis of Amino Acrylate Oligomers. Amino acrylates based on diethanolamine have two reactive hydroxyl groups and, therefore, can function as a polyol to synthesize urethane acrylate resins. Moreover, as is shown in FIG. 1, secondary amine nitrogens may be derivatized by a Michael-type (=“pseudo” Michael) addition to a multi-functional acrylate monomer or oligomer. The tertiary amine so formed can function as an amine synergist to promote the cure of subsequently formed acrylic oligomer resins. The oligomer of FIG. 1 may be termed a tertiary amino acrylate polyol. This reaction may be described generally as the reaction of a multi-functional acrylate with a poly hydroxyl-functional secondary amine to form a tertiary amino acrylate polyol (TAAPO) oligomer.

The present invention is not limited to diethanolamine. Rather any dialkanolamine is suitable. Moreover, the hydroxyl functional carbon radical may suitably be chosen from among alkanes, alkenes, and alkynes. The secondary amine nitrogen may be a constituent of a dihydroxyl functional heterocyclic compound. Diethanolamine is a preferred, non-limiting, dialkanolamine. The acrylate may suitably be any di-, tri-, or higher-order polyacrylate.

Suitable, non-limiting diacrylates include ethylene glycol diacrylate, propylene glycol diacrylate, diethylene glycol diacrylate, dipropylene glycol diacrylate, triethylene glycol diacrylate, tripropylene glycol diacrylate, tertraethylene glycol diacrylate, tetrapropylene glycol diacrylate, polyethylene glycol diacrylate, polypropylene glycol diacrylate, ethoxylated bisphenol A diacrylate, bisphenol A diglycidyl ether diacrylate, resorcinol diglycidyl ether diacrylate, 1,3-propanediol diacrylate, 1,4-butanediol diacrylate, 1,5-pentanediol diacrylate, 1,6-hexanediol diacrylate, neopentyl glycol diacrylate, cyclohexane dimethanol diacrylate, ethoxylated neopentyl glycol diacrylate, propoxylated neopentyl glycol diacrylate, ethoxylated cyclohexanedimethanol diacrylate, propoxylated cyclohexanedimethanol diacrylate, epoxy diacrylate, aryl urethane diacrylate, aliphatic urethane diacrylate, polyester diacrylate, and mixtures thereof.

Suitable, non-limiting triacrylates include trimethylol propane triacrylate, glycerol triacrylate, ethoxylated trimethylolpropane triacrylate, propoxylated trimethylolpropane triacrylate, tris (2-hydroxyethyl) isocyanurate triacrylate, ethoxylated glycerol triacrylate, propoxylated glycerol triacrylate, pentaerythritol triacrylate, aryl urethane triacrylates, aliphatic urethane triacrylates, melamine triacrylates, epoxy novolac triacrylates, aliphatic epoxy triacrylate, polyester triacrylate, and mixtures thereof.

Suitable, non-limiting higher-order acrylates include di-tri methylol propane tetraacrylate, pentaerythritol tetraacrylate, ethoxylated pentaerythritol tetraacrylate, propoxylated pentaerythritol tetraacrylate, dipentaerythritol tetraacrylate, ethoxylated dipentaerythritol tetraacrylate, propoxylated dipentaerythritol tetraacrylate, aryl urethane tetraacrylates, aliphatic urethane tetraacrylates, polyester tetraacrylates, melamine tetraacrylates, epoxy novolac tetraacrylates, and mixtures thereof.

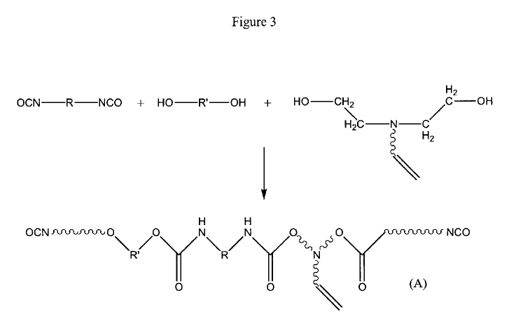

FIG. 3 depicts the synthesis of an N-bis-(isocyanate-terminated urethane) tertiary amino acrylate from polyisocyanates, polyols, and the tertiary amino acrylate polyol of FIG. 1.

The present invention relates to Michael resins synthesized from at least one oligomer derived from N-bis-(isocyanate-terminated urethane) tertiary amino acrylate and at least one β-dicarbonyl monomer. In a first embodiment, a β-dicarbonyl is at the center of a Michael resin formed by replacing the active hydrogens of the dicarbonyl with oligomers derived from N-bis-(isocyanate-terminated urethane) tertiary amino acrylates. In a second embodiment, a Michael resin having peripherally-located β-dicarbonyl chromophores is formed from N-bis-(isocyanate-terminated urethane) tertiary amino acrylate oligomer, each isocyanate termination of which forms a urethane bond with a hydroxyl-functional Michael oligomer.

### EXAMPLE 1

### Amino Acrylate Polyol Oligomer Based on HDDA and DEA

Hexanediol diacrylate (HDDA) (108.5 g, 0.480 mols) was added to a 500 mL reactor equipped with a mechanical stirrer and thermocouple. Diethanolamine (50 g, 0.480 mols) was added slowly to the reactor with constant stirring. After about 1 hour, an exotherm was observed to peak at about 45° C. The reaction mixture was then heated with a mantle to about 70° C., to drive the reaction to completion, and then cooled to room temperature. The amino acrylate was transferred to an amber-colored glass bottle for storage. ¹³C NMR confirmed that all the amine had reacted to give the desired product which was a clear; slightly yellow liquid of moderate viscosity.

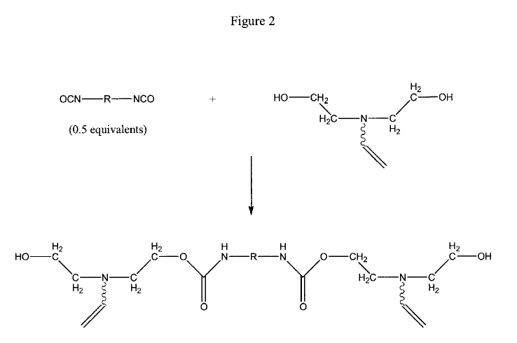

The tertiary amino acrylate polyol of Example 1 (FIG. 1) may be reacted in excess over a polyisocyanate to form dimers and higher-order oligomers. (FIG. 2). Alternatively, tertiary amino acrylate diols may be reacted with additional polyols and a stoichiometric excess of isocyanates to yield N-bis-(isocyanate-terminated urethane) tertiary amino acrylate oligomers (N-bis-(ITU)TAA) as shown in FIG. 3.

FIG. 2 illustrates the use of a preferred diisocyanate, hexamethylene diisocyanate (HDI). However, the invention is not limited to HDI. Suitable, non-limiting diisocyanates include dicyclohexylmethane diisocyanate (H12 MDI), isophorone diisocyanate (IPDI), and 2,2,4-trimethylhexamethylene diisocyanate (TMDI).

### EXAMPLE 2

### Synthesis of N-bis-(Hydroxyl-Terminated Urethane) Tertiary Amino Acrylate Oligomer (HDDA/DEA/HDI)

FIG. 2 depicts the synthesis of an N-bis-(hydroxyl-terminated urethane) tertiary amino acrylate oligomer. The embodiment in example 2 realizes a monoacrylate moiety pendant from the tertiary amine. Hexanediol diacrylate (217 g 0.96 mols) and diethanolamine (100 g, 0.96 mols) were reacted as in Example 1 and the product cooled to room temperature. Monochlorophenyl phosphate (MCPP, 22 drops), phenothiazine (0.06 g, 150 ppm) and Dibutyltin dilaurate (8 drops) were added to the reaction mixture followed by the slow addition of hexamethylene diisocyanate (HDI, 80.2 g, 0.48 mol). The reaction is very exothermic and the temperature was controlled under 40° C. using an ice bath. Following HDI addition, the reaction mixture was stirred at room temperature for another hour. Completion of the reaction was confirmed by monitoring the consumption of —NCO groups by IR spectroscopy. The product was a viscous, flowable clear liquid that cured tack-free with exposure to UV light (600 W/inch lamp at a dosage of 500 mJ/cm²) and yielded a clear, glossy coating. The coating was found to have solvent resistance of <100 MEK rubs.

### EXAMPLE 3

### Synthesis of N-bis-(Hydroxyl-Terminated Urethane) Tertiary Amino Acrylate Oligomer (TMPTA/DEA/HDI)

FIG. 2 depicts the synthesis of an N-bis-(hydroxyl-terminated urethane) tertiary amino acrylate oligomer. This embodiment in example 3 realizes a diacrylate moiety pendant from the tertiary amine and yields resins having a greater cross-link density than does the oligomer of Example 2. A 100 mL resin kettle equipped with a mechanical stirrer and thermocouple was loaded with trimethylolpropane triacrylate (TMPTA, 28.5 g, 0.096 mols). Diethanolamine (10 g, 0.096 mols) was added slowly to the reactor with constant stirring. After about one hour, a peak exotherm of 42° C. was observed. The reaction mixture was then heated to 70° C. using a mantle for about an hour to ensure complete reaction and then cooled to room temperature. Monochlorophenyl phosphate (MCPP, 2 drops) and dibutyltin dilaurate (1 drop) were added to the reaction mixture followed by the slow addition of hexamethylene diisocyanate (HDI, 4.1 g, 0.024 mol). The reaction was very exothermic and temperature was controlled under 40° C. using an ice bath. The reaction was stirred for 3 h at room temperature after HDI addition, before it was confirmed by IR that all NCO had been consumed. The product is a highly viscous clear liquid, which cures tack-free with exposure to UV light (600 W/inch lamp and a dosage of 500 mL/cm²) to give a clear, glossy coating. The coating was found to have solvent resistance of >200 MEK rubs.

### EXAMPLE 4

### Synthesis of an Isocyanate End-capped N-bis-(Urethane) Tertiary Amino Acrylate Oligomer.

FIG. 3 is a schematic of the second synthetic route of the present invention; a path which results in the synthesis of an isocyanate end-capped N-bis-(urethane) tertiary amino acrylate oligomer by the reaction of a diisocyanate with acrylate-functional dialkanol amine and an additional polyol. This product may be termed as N-bis-(isocyanate-terminated urethane) tertiary amino acrylate (N-bis-(ITU)TAA). As depicted, mono amino acrylate (as described in Example 1) is reacted with a glycol and a diisocyanate.

Suitable, non-limiting, polyols include polyether and polyester polyols and other glycols such as 1, 6-hexanediol, neopentyl glycol and hydrogenated bisphenol A. Polypropylene glycols are preferred.

Suitable, non-limiting diisocyanates include hexamethylene diisocyanate (HDI), dicyclohexylmethane diisocyanate (H12 MDI), isophorone diisocyanate (IPDI), and 2, 2, 4-trimethylhexamethylene diisocyanate (TMDI). Preferred diisocyanates include hexamethylene diisocyanate and isophorone diisocyanate.

### EXAMPLE 5

### Synthesis of an N-bis-(Isocyanate-Terminated Urethane) Tertiary Amino Acrylate Oligomer (N-bis-(ITU)TAA)

A 100 mL resin kettle equipped with a mechanical stirrer and thermocouple was purged with nitrogen for about 2 minutes and then loaded with isophorone diisocyanate (IPDI, 44.1 g, 0.05 mol), hexamethylene diisocyanate (HDI, 8.4 g, 0.05 mol), dipropylene glycol diacrylate (DPGDA, 20.3 g, 0.084 mol), monochlorophenyl phosphate (MCPP, 3 drops) and phenothiazine (0.0036 g, 50 ppm). In the synthesis of the present example, DPGDA is an inert acrylate monomer present as a diluent. Dibutyltin dilaurate (T-12, 2 drops) was added and stirred for a couple of minutes. Dipropylene glycol (DPG, 3.4 g, 0.025 mols) and amino acrylate from Example 1 (HDDA+DEA) (8.3 g, 0.025 mols) were added slowly keeping the peak temperature at approximately 65° C. At the conclusion of polyol addition, the resin was cooked until >95% of the —OH groups were reacted as determined by infrared spectroscopy.

Synthesis of an N-bis-(acrylate-terminated urethane) tertiary amino acrylate oligomer (N-bis-(ATU)TAA) is accomplished by reacting the isocyanate groups of example 5 with a hydroxyl-functional acrylate (e.g., 2-HEA, HPA, etc.) to form a urethane.

A preferred hydroxyl functional acrylate is 2-hydroxyethyl acrylate (HEA). Non-limiting examples of suitable hydroxyacrylates include 2-hydroxyethyl acrylate (HEA), 2-hydroxypropyl acrylate (HPA), 4-hydroxybutyl acrylate, 2-hydroxybutyl acrylate, caprolactone acrylate, polyethylene glycol monoacrylate, polypropylene glycol monoacrylate, and mixtures thereof.

### EXAMPLE 6

### Synthesis of an N-bis-(Acrylate-Terminated Urethane) Tertiary Amino Acrylate

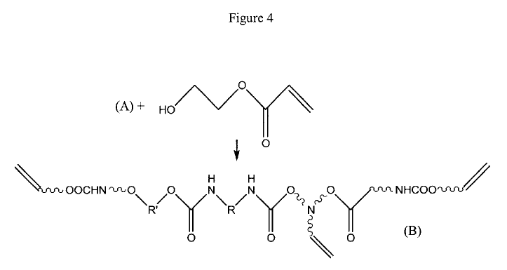

The reaction in Example 5 was maintained for 3 hours and then hydroxyethyl acrylate (HEA, 11.9 g, 0.102 mols) was added slowly keeping temperature around 65° C. The reaction was continued overnight at room temperature until all —NCO groups were consumed as per IR. The synthesis of this product is depicted in FIG. 4.

### EXAMPLE 7

### Synthesis of a Tertiary Amino Acrylate-Based Michael Resin Having a Central Dicarbonyl Chromophore

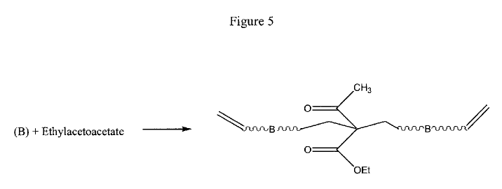

FIG. 5 depicts the synthesis wherein a β-dicarbonyl monomer and an N-bis-(ATU)TAA react in the presence of a Michael addition-promoting base catalyst to form an N-bis-(acrylate-terminated urethane) tertiary amino acrylate-based resin having a central dicarbonyl chromophore. The reaction mixture of Example 6 was cooled to 50° C. and DBU (1, 8 diazabicyclo [5.4.0] undec-7-ene, 0.65 g, 0.9% w/w) was added followed by the slow addition of ethyl acetoacetate (EAA 8.5 g, 0.065 mols). The reaction mixture was stirred at 80° C. for 2 hours, cooled to room temperature, and transferred to a dark-colored bottle. This product (FIG. 5) is a very viscous liquid, which is almost solid at room temperature. Quantitative NMR confirmed the formation of 100% disubstituted EAA reaction product. The product was found to be stable even after standing for more than 2 months.

### EXAMPLE 8

### Coating Properties of a Tertiary Amino Acrylate-based Michael Resin Having a Central Dicarbonyl Chromophore.

The product from Example 4 was cross-linked under UV light (600 W/inch lamp and a dosage of 500 mJ/cm²) and gave a clear, glossy, tack-free coating on aluminum and steel panels. The coating had very good solvent resistance (>200 MEK rubs), very good crosshatch adhesion to steel (5 B), poor pencil hardness (b-soft) and relatively low mar resistance (70%).

### EXAMPLE 9

### Synthesis of a Hydroxyl-Functional Michael Oligomer

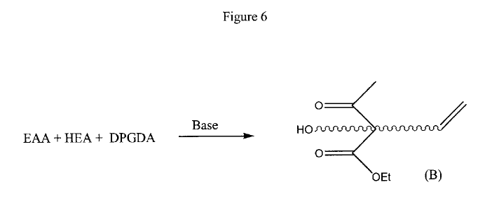

FIG. 6 depicts the synthesis of a hydroxyl-functional Michael oligomer. A 100 mL reactor, equipped with a magnetic stirrer and thermocouple, was charged with DPGDA (30.7 g., 0.127 mols) and HEA (14.7 g, 0.127 mols). DBU (0.54 g, 0.9% ww) was added and the reaction mixture was stirred. EAA (15 g, 0.115 mols) was added slowly and the exotherm of the reaction was monitored. A temperature maximum of 80° C. was reached and maintained for 2 hours. The final product was a clear, slightly yellow liquid of moderate viscosity. The product was stored in an amber-colored glass bottle. ¹³C NMR confirmed that about 85% of the disubstituted EAA product was obtained.

### EXAMPLE 10

### Synthesis of an N-bis-(Urethane Acrylate) Tertiary Amino Acrylate Based Michael Resin Having Peripheral β-Dicarbonyl Chromophores

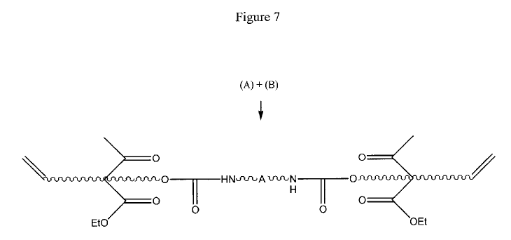

FIG. 7 depicts the reaction of an N-bis-(ITU)TAA and a hydroxyl-functional Michael acrylate oligomer in the presence of a urethane-promoting catalyst to form an N-bis-(urethane acrylate) tertiary amino acrylate based Michael resin having peripheral β-dicarbonyl chromophores. A 100 mL resin kettle equipped with a mechanical stirrer and thermocouple was purged with nitrogen for about 2 minutes prior to loading with isophorone diisocyanate (IPDI, 11.1 g, 0.05 mol), hexamethylene diisocyanate (HDI, 8.4 g, 0.05 mol), monochlorophenyl phosphate (MCPP, 3 drops) and phenothiazine (0.0041 g, 50 ppm). Dibutyltin dilaurate (T-12, 2 drops) was added and stirred for a couple of minutes. Dipropylene glycol (DPG, 3.4 g, 0.025 mols) and amino acrylate [HDDA+DEA] (8.3 g, 0.025 mols) were added slowly, keeping the temperature peak at approximately 65° C. At the conclusion of polyol addition, the resin was cooked until infrared spectroscopy (IR) showed consumption of >95% of —OH groups. At the end of 3 h, the —OH containing Michael resin as synthesized in Example 9.(49.8 g, 0.102 mols) was added slowly keeping temperature around 65° C. The reaction was continued overnight at room temperature until all —NCO was consumed as per IR. The final product is a very viscous liquid, which is almost solid at room temperature.

### EXAMPLE 8

### Coating Properties of a Tertiary Amino Acrylate-based Michael Resin Having Peripheral β-Dicarbonyl Chromophores

The product from Example 10 was cross-linked under UV light (600 W/inch lamp and a dosage of 500 mL/cm²) to give a clear, glossy, tack-free coating on aluminum and steel panels. The coating had very good solvent resistance (>200 MEK rubs), poor crosshatch adhesion to steel (0 B), poor pencil hardness (hb-soft) and relatively low mar resistance (70%).

### INCORPORATED BY REFERENCE

All publications and patent applications cited in this specification are herein incorporated by reference, and for any and all purposes, as if each individual publication or patent application were specifically and individually indicated to be incorporated by reference. In the case of inconsistencies the present disclosure will prevail. Specifically, all ASTM test methods referred to herein are specifically incorporated in their respective entireties and for all purposes. In particular, the entire contents of co-pending applications serial numbers (not yet assigned) (attorney docket numbers 20435/141, 20435/144, 20435/145, 20435/146, 20435/147, 20435/148, 20435/151, and 20435/156 are explicitly incorporated by reference and for all purposes.

What is claimed as new and desired to be protected by Letters Patent of the United States is:

1. An N-bis-(urethane) tertiary amino acrylate pseudo Michael resin comprising at least one Michael oligomer linked to at least one N-bis-(urethane) tertiary amino acrylate oligomer.

2. The N-bis-(urethane) tertiary amino acrylate pseudo Michael resin, according to claim 1, wherein said N-bis-(urethane) tertiary amino acrylate oligomer comprises:
a tertiary amino acrylate polyol having at least two primary hydroxyl groups;
first, and second, isocyanate-terminated urethane oligomers respectively in urethane linkage to said primary hydroxyl groups.

3. The N-bis-(urethane) tertiary amino acrylate Michael resin, according to claim 2, wherein said isocyanate-terminated urethane oligomer comprises the reaction of one or more polyols with multi-functional isocyanate.

4. The N-bis-(urethane) tertiary amino acrylate Michael resin, according to claim 2, wherein said tertiary amino acrylate polyol comprises a multi-functional acrylate linked to an amine containing two or more primary hydroxyl groups by a pseudo Michael type addition.

5. The N-bis-(urethane) tertiary amino acrylate Michael resin, according to claim 4, wherein said amine polyol comprises a nitrogen covalently linked to two organic radicals, wherein each said radical is selected from the group consisting of linear and branched alkyl, linear and branched alkenyl, and linear and branched alkynyl, and where each said radical bears a hydroxyl group.

6. The N-bis-(urethane) tertiary amino acrylate Michael resin, according to claim 5, wherein the secondary amine is part of a heterocyclic ring containing two or more primary hydroxyl groups.

7. The N-bis-(urethane) tertiary amino acrylate Michael resin, according to claim 5, wherein a preferred amine polyol is diethanolamine.

8. The N-bis-(urethane) tertiary amino acrylate Michael resin, according to claim 4, wherein said multi-functional acrylate is selected from the group consisting of diacrylates, triacrylates, tetraacrylates, pentaacrylates, higher-order acrylates, and mixtures thereof.

9. The N-bis-(urethane) tertiary amino acrylate Michael resin, according to claim 8, wherein said diacrylate is selected from the group consisting of:
ethylene glycol diacrylate, propylene glycol diacrylate,
diethylene glycol diacrylate, dipropylene glycol diacrylate,
triethylene glycol diacrylate, tripropylene glycol diacrylate,
tertraethylene glycol diacrylate, tetrapropylene glycol diacrylate,
polyethylene glycol diacrylate, polypropylene glycol diacrylate,
ethoxylated bisphenol A diacrylate, bisphenol A diglycidyl ether diacrylate,
resorcinol diglycidyl ether diacrylate, 1, 3-propanediol diacrylate,
1, 4-butanediol diacrylate, 1, 5-pentanediol diacrylate,
1, 6-hexanediol diacrylate, neopentyl glycol diacrylate,
cyclohexane dimethanol diacrylate, ethoxylated neopentyl glycol diacrylate,
propoxylated neopentyl glycol diacrylate,
ethoxylated cyclohexanedimethanol diacrylate,
propoxylated cyclohexanedimethanol diacrylate, acrylated epoxy diacrylates,
aryl urethane diacrylates, aliphatic urethane diacrylates, polyester diacrylates,
and mixtures thereof.

10. The N-bis-(urethane) tertiary amino acrylate Michael resin, according to claim 8, wherein said triacrylate is selected from the group consisting of:
trimethylol propane triacrylate, glycerol triacrylate,
ethoxylated trimethylolpropane triacrylate,
propoxylated trimethylolpropane triacrylate,
tris (2-hydroxyethyl) isocyanurate triacrylate, ethoxylated glycerol triacrylate,
propoxylated glycerol triacrylate, pentaerythritol triacrylate,
aryl urethane triacrylates, aliphatic urethane triacrylates,
melamine triacrylates, aliphatic epoxy triacrylates, epoxy novolac triacrylates,
polyester triacrylates and mixtures thereof.

11. The N-bis-(urethane) tertiary amino acrylate Michael resin, according to claim 8, wherein said tetraacrylate is selected from the group consisting of:
di-trimethylolpropane tetraacrylate, pentaerythritol tetraacrylate,
ethoxylated pentaerythritol tetraacrylate,
propoxylated pentaerythritol tetraacrylate, dipentaerythritol tetraacrylate,
ethoxylated dipentaerythritol tetraacrylate,
propoxylated dipentaerythritol tetraacrylate, aryl urethane tetraacrylates,
aliphatic urethane tetraacrylates, melamine tetraacrylates,
epoxy novolac tetraacrylates, and mixtures thereof.

12. The N-bis-(urethane) tertiary amino acrylate Michael resin, according to claim 8, wherein said pentaacrylate is selected from the group consisting of dipentaerythritol pentaacrylate, melamine pentaacrylate, novolac pentaacrylates and mixtures thereof.

13. The N-bis-(urethane) tertiary amino acrylate Michael resin, according to claim 3, wherein said polyol is selected from the group consisting of polyester and polyether polyols and glycols.

14. The N-bis-(urethane) tertiary amino acrylate Michael resin, according to claim 13, wherein a preferred polyol is poly propylene glycol.

15. The N-bis-(urethane) tertiary amino acrylate Michael resin, according to claim 3, wherein said polyisocyanate is selected from the group consisting of hexamethylene diisocyanate (HDI), dicyclohexylmethane diisocyanate (H12 MDI), isophorone diisocyanate (IPDI), and 2,2,4-trimethylhexamethylene diisocyanate (TMDI).

16. An N-bis-(urethane) tertiary amino acrylate Michael resin, having a central β-dicarbonyl, comprising:
a β-dicarbonyl monomer; and
at least one N-bis-(urethane) tertiary amino acrylate oligomer of claim 2 Michael added to said β-dicarbonyl.

17. The N-bis-(urethane) tertiary amino acrylate Michael resin, having a central β-dicarbonyl, according to claim 16, further comprising two N-bis-(urethane) tertiary amino acrylate oligomers of claim 2 Michael added to said β-dicarbonyl.

18. The N-bis-(urethane) tertiary amino acrylate Michael resin, having a central β-dicarbonyl, according to claim 16, further comprising N-bis-(urethane) tertiary amino acrylate oligomers generated by addition of hydroxyacrylate monomers or oligomers to isocyanate terminations of N-bis-(isocyanate-terminated urethane) tertiary amino acrylate oligomer.

19. The N-bis-(urethane) tertiary amino acrylate Michael resin, having a central β-dicarbonyl, according to claim 18, wherein said hydroxyacrylate is chosen from the group consisting of 2-hydroxyethyl acrylate (HEA), 2-hydroxypropyl acrylate (HPA), 4-hydroxybutyl acrylate, 2-hydroxybutyl acrylate, caprolactone acrylate, polyethylene glycol monoacrylate, polypropylene glycol monoacrylate, and mixtures thereof.

20. The N-bis-(urethane) tertiary amino acrylate Michael resin, having a central β-dicarbonyl, according to claim 18, wherein a preferred hydroxyacrylate is 2-hydroxyethyl acrylate (HEA).

21. The N-bis-(urethane) tertiary amino acrylate Michael resin, having a central β-dicarbonyl, according to claim 16, wherein said β-dicarbonyl monomer is selected from the group consisting of β-keto esters, β-diketones, β-keto amides, β-ketoanilides, and cyanoacetates.

22. The N-bis-(urethane) tertiary amino acrylate Michael resin, having a central β-dicarbonyl, according to claim 21, wherein a preferred β-dicarbonyl monomer is selected from the group consisting of ethyl acetoacetate, 2, 4-pentanedione, acetoacetamide and acetoacetanilide.

23. The N-bis-(urethane) tertiary amino acrylate Michael resin, having a peripheral β-dicarbonyl, comprising an N-bis-(urethane) tertiary amino acrylate oligomer of claim 2 in urethane linkage with at least one hydroxyl-functional Michael acrylate oligomer.

24. The N-bis-(urethane) tertiary amino acrylate Michael resin, having a peripheral β-dicarbonyl, according to claim 23, comprising at least two hydroxyl-functional Michael acrylate oligomers.

25. The N-bis-(urethane) tertiary amino acrylate Michael resin, having a peripheral β-dicarbonyl, according to claim 24, wherein said hydroxyl-functional Michael acrylate oligomer comprises:
a β-dicarbonyl monomer;
a hydroxyl-functional acrylate Michael added to said β-dicarbonyl; and
a multi-functional acrylate Michael added to said β-dicarbonyl.

26. A UV-curable resin composition comprising the resin of claim 1 and at least one additive selected from the group consisting of photoinitiators, pigments, gloss modifiers, flow and leveling agents and other additives as appropriate to formulate coatings, paints, laminates, sealants, adhesives, foundry sand binders, and inks.

27. A method of using a UV-curable composition comprising applying the resin of claim 1 to a substrate and curing said resin.

28. The method of using a UV-curable composition, according to claim 27, further comprising providing at least one additive selected from the group consisting of photoinitiators, pigments, gloss modifiers, flow and leveling agents and other additives as appropriate to formulate coatings, paints, laminates, sealants, adhesives, foundry sand binders, and inks.

29. A substrate coated with the resin of claim 1.

30. A device containing the resin of claim 1.

31. A method of synthesizing an N-bis-(urethane) tertiary amino acrylate Michael resin, having a central β-dicarbonyl, comprising:
providing a resin reactor having a dry atmosphere;
providing a β-dicarbonyl monomer;
providing an N-bis-(acrylate-terminated urethane) tertiary amino acrylate oligomer; and
providing a Michael addition catalyst.

32. The method of synthesizing an N-bis-(urethane) tertiary amino acrylate Michael resin, having a central β-dicarbonyl, according to claim 31, wherein said Michael addition catalyst is selected from the group consisting of diazabicycloundecene, diazabicyclononene, 1,1,3,3-tetramethyl guanidine, Group I alkoxide bases, quaternary hydroxides and alkoxides, and organophilic alkoxide bases generated in situ from the reaction between a halide anion and an epoxide moiety.

33. The method of synthesizing an N-bis-(urethane) tertiary amino acrylate Michael resin, having a central β-dicarbonyl, according to claim 31, wherein providing said N-bis-(acrylate-terminated urethane) tertiary amino acrylate oligomer comprises:
providing a resin reactor having a dry atmosphere;
providing an N-bis-(isocyanate-terminated urethane) tertiary amino acrylate oligomer;
providing a hydroxyl-functional acrylate; and
providing a urethane-promoting catalyst.

34. The method of synthesizing an N-bis-(urethane) tertiary amino acrylate Michael resin, having a central β-dicarbonyl, according to claim 33,
wherein said urethane-promoting catalyst is selected from the group consisting of dibutyltin dilaurate, tin(II) octoate, and diazabicyclo[2.2.2]octane.

35. The method of synthesizing an N-bis-(urethane) tertiary amino acrylate Michael resin, having a central β-dicarbonyl, according to claim 33, wherein providing said N-bis-(isocyanate-terminated urethane) tertiary amino acrylate oligomer comprises:
providing a resin reactor having a dry atmosphere;
providing a tertiary aminoacrylate diol oligomer;
providing a polyol;
providing a polyisocyanate; and
providing a urethane-promoting catalyst.

36. The method of synthesizing an N-bis-(urethane) tertiary amino acrylate Michael resin, having a central β-dicarbonyl, according to claim 33, wherein providing said tertiary aminoacrylate diol oligomer comprises:
providing a resin reactor having a dry atmosphere;
providing an amine polyol; and
providing a multi-functional acrylate.

37. A method of synthesizing an N-bis-(urethane) tertiary amino acrylate Michael resin, having a peripheral β-dicarbonyl comprising:
providing a resin reactor having a dry atmosphere;
providing an N-bis-(isocyanate-terminated urethane) tertiary amino acrylate oligomer;
providing a hydroxyl-functional Michael oligomer; and
providing a urethane-promoting catalyst.

38. The method of synthesizing an N-bis-(urethane) tertiary amino acrylate Michael resin, having a peripheral β-dicarbonyl, according to claim 38, wherein providing a hydroxyl-functional Michael oligomer comprises:
providing a resin reactor having a dry atmosphere;
providing a β-dicarbonyl;
providing a hydroxyl-functional acrylate;
providing a multi-functional acrylate; and
providing a Michael addition catalyst.
